(19) United States
(12) Patent Application Publication
(10) Pub. No.: US 2012/0246302 A1
(43) Pub. Date: Sep. 27, 2012

(54) SYSTEM AND METHODOLOGY FOR CREATING AND USING CONTEXTUAL USER PROFILES

(75) Inventors: Jean Lafleur, Paris (FR); Jonathan Benassaya, Menlo Park, CA (US)

(73) Assignee: MILESTONE PROJECT INC., San Francisco, CA (US)

(21) Appl. No.: 13/426,310

(22) Filed: Mar. 21, 2012

Related U.S. Application Data
(60) Provisional application No. 61/466,234, filed on Mar. 22, 2011.

(30) Foreign Application Priority Data
Mar. 22, 2011 (FR) 1000106891

(51) Int. Cl. G06F 15/173

(52) U.S. Cl. 709/224

(57) ABSTRACT

A computing device receives an indication of an action performed on a resource by a user of a user device. The computing device stores context data corresponding to the action and analyzes the indication of the action with respect to the context data, to determine a user affinity value for a criteria associated with the resource. The computing device stores the user affinity value for the criteria in a contextual user profile associated with the user.

### RELATED APPLICATIONS

This application is related to and claims the benefit of U.S. Provisional Patent Application No. 61/466,234 filed on Mar. 22, 2011, and French Patent Application No. 1000106891 filed on Mar. 22, 2011, the contents of which are hereby incorporated by reference.

### TECHNICAL FIELD

This disclosure relates to the field of identifying user preferences, and in particular, to creating and using contextual user profiles.

### BACKGROUND OF THE INVENTION

Modern customers are inundated with choices. Matching customers with the most appropriate or preferred products, services or content is not a trivial task, yet is a fundamental way to enhance user satisfaction and brand/content penetration.

### SUMMARY OF THE INVENTION

A system and method are disclosed for building dynamic contextual user profiles comprising internet-connected devices, one or more extensions on the devices capable of logging user actions on the devices, one or more processors capable of interpreting and sorting the raw log data according to a pre-defined list of actions processed, and generating data values to create or update the user profile according to the device used, the hour and day of use, the place of use, the mood of the user and the user's personal or professional condition. The profile of a user may represent preferences based on a list of actions with no limitation other than the ones set by the list of actions processed. Then, systems and methods for building contextual recommendations based upon dynamic contextual user profiles are also disclosed. Contextual recommendations may be based upon existing recommendation algorithms, such as collaborative filtering among others. Recommendations can be delivered on the same interface from which user actions are logged or on other interfaces. In addition, the contextual recommendations may be further refined and enhanced through the use of social recommendations which are based on the behaviors and actions of a user's friends and acquaintances on various social networking sites. Finally, a system and method for creating customized lists of content based upon explicit requests and/or upon dynamic contextual user profiles and/or simple user profiles are disclosed. Lists of content can be delivered on the same interface from which user actions are logged or on other interfaces. In addition, the customized list of content may be further refined and enhanced through the use of existing customized lists of content created by other users or friends of the users on various social networking sites.

In one embodiment, a profile generation engine receives an indication of an action performed on a resource by a user of a user device. The profile generation engine stores context data corresponding to the action and analyzes the indication of the action, with respect to the context data, to determine a user affinity value for a criteria associated with the resource. The profile generation engine stores the user affinity value for the criteria in a contextual user profile associated with the user. In one embodiment, analyzing the indication of the action with respect to the context data may include comparing the indication of the action to reference data based on the context data. Based on that comparison, the profile generation engine may determine an interpretation value and then determine the affinity value from the interpretation value. In one embodiment, storing the user affinity value in a contextual user profile may include generating a multi-dimensional matrix that includes the user affinity value and one or more additional user affinity values. Each dimension of the matrix may corresponds to a different contextual factor or criteria, and each of the one or more additional user affinity values may correspond to a change in the different contextual factors or criteria.

In one embodiment, a recommendation engine may receive a request for content from the user of the user device. In response to the request, the recommendation engine may identify a context of the request based on context data received with the request and may compare the context data to the contextual user profile associated with the user. Based on that comparison, the recommendation engine may identify a resource to satisfy the request for content. Comparing the context data to the contextual user profile may include identifying a user affinity value for the context data from the contextual user profile. Identifying the resource may include comparing the user affinity value to a resource value to determine if the resource is recommended for the user. In addition, identifying the resource may also include comparing the user affinity value to resource values from one or more other user profiles associated with users who have a virtual connection to the user. If the resource is recommended to the user, the recommendation engine may provide the resource to the user to satisfy the request for content.

### BRIEF DESCRIPTION OF THE DRAWINGS

The present invention will be more readily understood from the detailed description of exemplary embodiments presented below considered in conjunction with the attached drawings, of which:

FIG. 1a is a graphical representation of an exemplary user profile template, represented as a “n×1” column vector, for use in non-contextual recommendation engines.

FIG. 1b is a graphical representation of an exemplary user profile template represented as an “n×m” matrix, for use in recommendation engines with a temporal dimension according to “m” time slots.

FIG. 1c is a graphical representation of an exemplary user profile template represented as a 3-dimensional matrix, for use in recommendation engines with a temporal and device-dependent dimension.

FIG. 2 depicts a flowchart of a method for creating and updating a contextual user profile.

FIG. 3 depicts a flowchart of a method for extracting data based on user actions.

FIG. 4 depicts a flow chart of a method for extracting data from a user's writing actions.

FIG. 5 depicts a flowchart of a method for extracting and interpreting data to determine user mood in order to update or create a user profile with mood values.

FIG. 6a depicts a block diagram of a system architecture for creating and updating a user profile.

FIG. 6b depicts a block diagram of a system architecture for creating and updating a user profile.

FIG. 7 depicts a flowchart of a method for using contextual user profiles for recommendation purposes.

FIG. 8 depicts a flowchart of a method for using semantic tools to update item profiles in order to improve the quality of the recommendation outputs.

FIG. 9 depicts a flowchart of a method for delivering social and contextual recommendations based on items for which no data could be gathered.

FIG. 10 depicts a block diagram of a system architecture for delivering contextual and social recommendations with or without semantic enhancement.

FIG. 11 depicts a flowchart of a method for creating customized lists of content from explicit user requests such as keywords and filters.

FIG. 12a depicts a flowchart of a method for using a user profile, contextual or not, for recommending full customized lists of content.

FIG. 12b depicts a flowchart of a method for using a user profile, contextual or not, for recommending full customized lists of content, which can be applied to creating customized lists of content based on social recommendations.

FIG. 13 depicts a flowchart of a method for using a user profile, contextual or not, for recommending full customized lists of content with constraints on content delivery at pre-determined times.

FIG. 14 depicts a flowchart of a method for using a user profile, contextual or not, for recommending full customized lists of content with filters determining the type of content comprised in the list.

FIG. 15 depicts a block diagram of a system architecture for creating customized lists of content based on explicit requests of users and/or user profiles, contextual or not.

FIG. 16 depicts a block diagram of a computer system, according to an embodiment.

### DETAILED DESCRIPTION OF THE INVENTION

### User Profiles

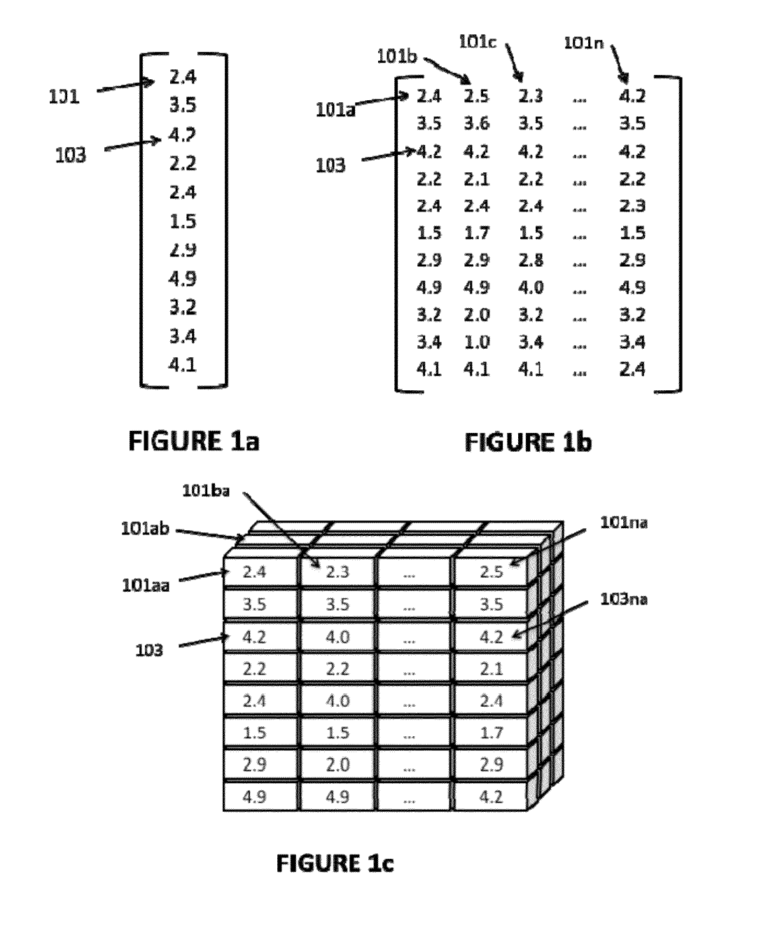

Building user profiles is a common practice when using recommendation engines. Such user profiles may be updated dynamically based on user actions and may be represented by a “n×1” column vector “U” which shows the user's preference for each of “n” criteria where “n” can be any number greater than or equal to 1. FIG. 1a depicts such a profile. These “n×1” profiles may then be matched with an item's profile as represented by another “n×1” column vector “I” to assess how well the item's profile matches the user's preferences. In general, by multiplying the two vectors (^{T}U*I) one can determine whether the user's profile correlates to the item's profile. Indeed, the criteria of the user profile and of the item profile are similar, and the values of criteria 101 or 103 of the user profile U (as shown in FIG. 1a) may stand for the user's affinity for the criteria. According to an embodiment of the present invention, the value of criteria 101 of the item profile I (as shown in FIG. 1a) may stand for the item's notation on the criteria. Algorithms such as collaborative filtering can then be developed based on these profiles to improve recommendations. For instance, the recommendation engine could look for users who share the same profile patterns with the user whom the predictions are for, and use the ratings of those like-minded users to calculate the predictions. Furthermore, comparing user profiles to item profiles may pave the way for improved collaborative filtering, and thus improved recommendations.

In one embodiment, user profiles may have “n×m” elements to allocate m “n×1” column vectors to one profile, as a user may, for example, behave differently with time, as presented in FIG. 1b. Such two dimensional user profiles may be sufficient for time-based recommendations. Indeed, one column vector may correspond to the user's preferences for some time window. For instance, in FIG. 1b, element 101b may represent the user's affinity for the first criteria for every morning of a workday. Element 101a may represent those for Monday evenings from 7 pm to 10 pm. A matrix can cover an unlimited number of time windows. Elements 101c-101n may represent a user's affinity for the first criteria during various other time windows. For example, the user profile may be a “n×m” matrix with n criteria and m time windows.

However, to provide recommendations dependent on additional criteria such as time, place, connected device used, mood of the user and other contextual information as the user's personal or professional condition—on holidays for instance—, it may be necessary to add more dimensions to the matrix.

Referring to FIG. 1c, contextual user profile matrixes can be of three dimensions. The first dimension may stand for the criteria on which notations are based, the second one may comprise time windows and the third one devices. For instance, a user may have four Internet-connected devices such as a television set, a smartphone, a tablet and a laptop. If m time windows have been relevant with the user's behavior (e.g., the time windows during which the user usually consumes content using the devices, a matrix of “n×m×4” may represent the user profile. If the user logs via a fifth device, the user profile matrix may be extended to an “n×m×5” matrix. A three-dimensional matrix may therefore be sufficient to cover time and device in the context of the user profile, as well as time and place, or mood and place. For example, element 101aa may represent a user's affinity for a first criteria during a first time window when using a first device (e.g., a smartphone). Element 101ba may represent the user's affinity for the first criteria during a second time window when using the first device and element 101ab may represent the user's affinity for the first criteria during the first time window when using a second device (e.g., a tablet). Elements 101na and 103na may represent the affinity for some other combination of criteria, time and device.

However, a full contextual user profile may comprise more than four dimensions, i.e. one for criteria, one for time windows, one for places, one for devices used. In addition, user mood could be allocated to a 5th dimension. One of ordinary skill in the art will appreciate that the number of dimensions is potentially unlimited. For instance, professional and personal conditions can be added as a 6^{th} dimension. The prior-art algorithms typically used with column vectors can be applied to multi-dimensional matrix profiles thus enabling more targeted and relevant recommendations. It is therefore an objective of the current invention to construct multi-dimensional user profiles.

According to an embodiment of the present invention, an item's profile vector column (referred to as “I”) can be modified in an “n×m×4” matrix having zeros for columns not adapted to the context that was selected. Multiplying the transposed user profile matrix ^{T}U to the item's profile matrix I will deliver a new matrix, in which only the corresponding resulting figure is considered for the result. Similarly, all collaborative filtering or other algorithms used for recommendations can be used with multi-dimension matrices for contextual recommendations.

This first part of the description of the invention sets the frame for a contextual user profile. The following part will first describe the methodology to build a user profile and then to dynamically update it and add some contextual dimensions to it.

### Constructing Initial User Profiles

When a user profile is first created, no user action has been logged to the profile. According to an embodiment of the present invention, a default user profile matrix can be built using average criteria values across existing user profiles. For example, the first user profile could begin as an “n×1” column vector corresponding to the average of all users' affinity for a given criteria. By way of example and not limitation, each element of the column vector could represent average user ratings for every song that comprises the criteria related to the element of the column. Each song could be assigned a different notation based on the notation of the criteria it comprises. Each explicit rating by any user of a song on the album would change the average of all users' affinity for the particular song or other criteria representative of the song.

According to an embodiment of the present invention, all elements in the default user profile matrix can be set to a pre-determined value for every user profile created. According to another embodiment of the present invention, a user's default profile can be constructed based on existing interactions on social networking sites such as Facebook. By way of example and not limitation, a user's default “n×1” column vector profile could be constructed from the average of all profiles that correspond to the user's friends on sites such as Facebook. According to another embodiment of the present invention, the videos shared, liked or commented upon on a user's social network accounts may help build the first user profile. Information gathered in the user's social network account may indicate preferences that can be linked to various criteria within the default profile. It is an objective of the present invention to update these user profiles so that each of them is the most accurate and provides the most information based on user context.

### Overview of Updating User Profiles

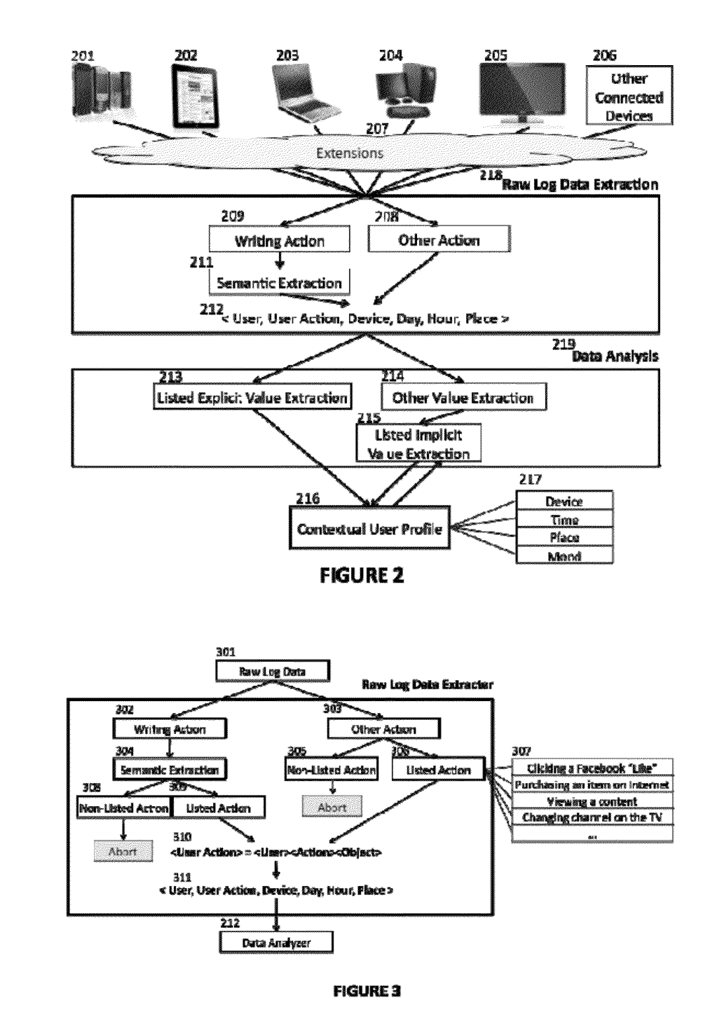

Exemplary embodiments of the present invention are described in detail with respect to FIG. 2, which depicts a flowchart of a method for creating and updating a contextual user profile. The system may comprise one or several Internet-connected devices, such as mobile phones 201, tablet computers 202, laptop computers 203, desktop computers 204, television sets 205 and other devices 206, such as set-top boxes and blu-ray players among others. These devices comprise some extensions 207, which may represent extensions to a web browser, applications, APIs, plug-ins, pieces of software on intermediary devices such as a set-top box, a game console or an over-the-top box (e.g., Apple TV, Roku Box, Boxee D-Link Box), among others. For instance, on mobile devices 201 and 202, the extensions 207 may represent applications running on the devices' local operating system. In this case, the extension will be able to log all User Actions and corresponding location, as determined from the device's on-board GPS or network-assigned IP address. In the case of laptop computers 203 and desktop computers 204, the extensions may represent desktop applications in which case the process may be similar to the extensions for mobile devices described above, or plug-ins in web browser, which are capable of logging user actions. In the case of televisions 205, the extension 207 may represent embedded applications on an internet-connected TV or pieces of software integrated in the operating system of a set-top box.

Once the actions are logged by the extensions 207, they are sent to the raw log data extraction module 218. The raw log data extraction module 218 first determines whether the actions are writing actions 209 or other actions 208. If the actions are determined to be writing actions 209, then such actions are sent to a semantic extraction module 211 for further analysis. If the logged actions are determined to be other actions 208, then they are output as is for further analysis by the data analysis module 219. The resulting output of the raw log data extraction module 218 is a “6×1” matrix 212 that contains the following elements: <User, User Action, Device, Day, Hour, Place>. The raw matrix is then sent to the data analysis module 219.

Place may be denoted using latitude and longitude coordinates output by the on-board GPS of mobile devices 201 and 202 or the IP addresses of the connected devices, 203, 204, 205 and 206.

The data analysis module 219 then analyzes the User Action element of the raw data matrix 212 to extract either explicit 213 or other values 214 which may be listed implicit values 215. The resulting output of the data analysis module 219 is to update the contextual user profile 216 against the criteria of device, time, place and mood 217.

### Raw Lot Data Extractor

According to an embodiment of the present invention and referring to FIG. 3, raw log data 301 is collected from the various extensions (207 in FIG. 2). As noted above, the raw log data contains various information concerning User Actions. The raw log data extractor first determines whether the User Action being logged is a writing action 302 or another action 303. If the action is a writing action 302, then the raw log data extractor performs a semantic extraction 304 as more fully described below. Once the semantic extraction 304 has been performed the particular User Action is defined as either being a listed action 309 or a non-listed action 308. Non-listed actions 308 are not defined by the system and thus cannot be used to update the contextual user profile. Therefore, if the raw log data extractor determines that a writing action 302 is a non-listed action 308, the process is aborted. However, if the writing action 302 is defined as a listed action 309, a “3×1” matrix 310 is output that has the following elements <User, Action/Sentiment, Object/Concept>. The object element may represent an item that was purchased on the Internet, a video that was viewed on a video platform or “liked” on Facebook or a video that the user began watching but then either changed the channel or stopped the video before completion. Alternatively, “3×1” matrix 310 can represent sentiments and concepts instead of actions and objects. For example, a concept could be broader than an object and could encompass activities such as “going to the movies” or “going out to dinner.” Instead of assigning an action, the raw log data extractor can assign a sentiment to each concept. For example, a user could have a “happy” or “positive” sentiment associated with “going out to dinner.” In this way, the raw log data extractor is capable of filtering and analyzing a limitless array of user activities. All Objects/Concepts are referenced in the data store.

If the raw log data extractor determines that the User Action is another action 303, then the raw log data extractor determines if the other action is a listed action 306 or a non-listed action 305. Non-listed actions 305 are not defined by the system and the process is aborted. However, if the other action 303 is determined to be a listed action 306, a “3×1” matrix 310 is output that has the following elements <User, Action, Object>. Examples of listed actions 306 include, without limitation, clicking a Facebook “like,” purchasing an item on the Internet, viewing content such as a video or changing the channel on the TV. In addition, viewing content multiple times, changing channel or skipping the video in the midst of its watching, fast forwarding or rewinding, updating a user's Facebook status are other examples of listed actions. Examples of listed actions are shown in 307. One having ordinary skill in the art will recognize that there is no limit to the kinds of listed actions 306 that can be defined according to embodiments of the present invention.

Non-listed actions 305 may represent all other actions that are not writing action and distinct from listed actions 306. As soon as an action is determined to be non-listed, the process may be aborted as specified above, as non-compliant to the system.

### Semantic Extraction

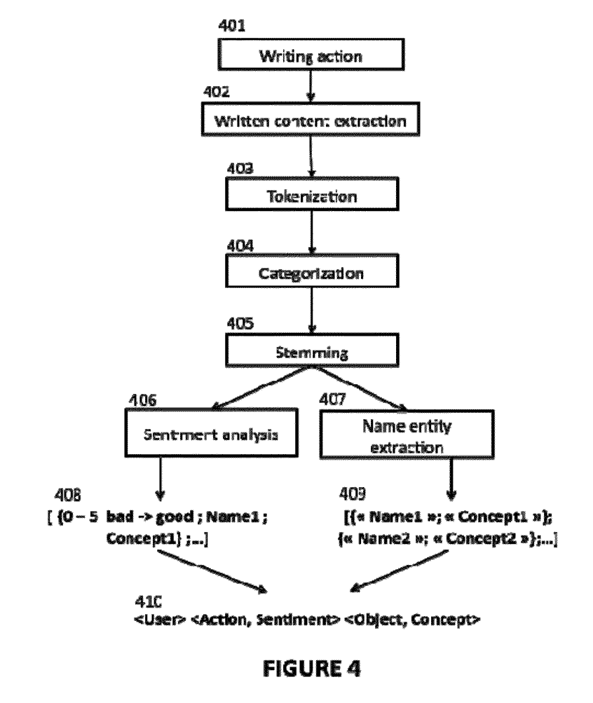

FIG. 4 depicts a flowchart of a method for performing a semantic extraction. Semantic extraction techniques are well-known in the art but will be discussed here for background purposes. The process may use already existing and external solutions with complete database of rules and words referenced.

According to one embodiment of the present invention, the written action 401 may be received and written content may be extracted 402. The extracted written content may be tokenized 403, after each sentence is broken into words, phrases, symbols or other meaningful elements. Then, the categorization 404 may group objects and words into categories, for instance the verb category for the word “watch,” which may follow with a stemming process 405 to deduce the root form of the different words. The next steps may include a sentiment analysis 406 to extract whether the subject may have a positive feeling with the concept 408, both of which may be extracted through some standard name entity extraction 407 to associate the name with the concept 409. Recombining both of them may build <Name><Sentiment><Concept> outputs out of the written input, which may be assimilated 410 to the <User><Action><Object> matrix mentioned above, when the name or the pronoun refers to the user.

### Data Analyzer

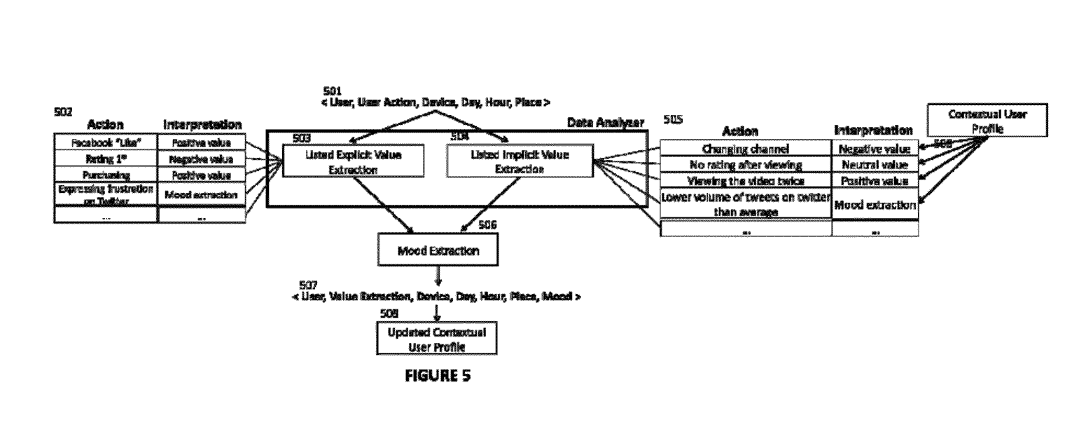

According to an embodiment of the present invention and referring to FIG. 5, the “6×1” raw log data matrix 501 is sent to the data analyzer. The data analyzer first determines whether the User Action is a listed explicit value 503 or a listed implicit value 504.

Examples of explicit User Actions are set forth in 502. For example, indicating on Facebook that a user “likes” something would be considered a listed explicit value 503. One having ordinary skill in the art will recognize that there is no limit to the number and types of actions that can be assigned explicit values 502.

Examples of listed implicit actions are set forth in 505. Actions such as changing the channel on a television set or not rating content after viewing on the Internet could be assigned listed implicit values. One having ordinary skill in the art will recognize that there is no limit to the number and types of actions that can be assigned listed implicit values 505.

Once the data analyzer has extracted listed explicit 503 and listed implicit 504 values from the raw log data matrix 501, the resulting values are sent to a mood extraction module 506 for further analysis. Mood values may be extracted either from listed explicit values 503 or listed implicit values 504. Examples of listed explicit values from which mood extractions may be performed are expressing frustration via Twitter. For example, if a user tweets “I can't find my lost puppy” the data analyzer can assign a mood value to such tweet. For example, the data analyzer could assign a mood value of “sad” or “negative” to the aforementioned tweet. Advantageously, the data analyzer can also assign mood values based on implicit markers such as tweet volume. By way of example and not limitation, if a user typically sends fifty (50) tweets every day and on a given day only sends ten (10) tweets, the data analyzer can assign a mood value based on the lower tweet volume. The system may assign a “sad” or “negative” value to lower-than-normal tweet volumes and a “happy” or “positive” value to higher-than-normal tweet volumes. An update of a user's Facebook status expressing joy may imply that the user has a positive mood. One of ordinary skill in the art will recognize that mood value extractions can be made from an unlimited number of User Actions.

Mood extraction is very delicate, but may have a significant influence on the user's preference. Therefore, mood value may comprise only neutral, negative and positive value. The mood may be neutral by default before any input, but any User Action indicating some positive or negative mood helps complete all user's input during the day by adding some mood dimension to the user profile matrix and a mood dimension to the processed input.

The resulting output of the mood extraction module 506 is a “7×1” matrix 507 having the following elements <User, Value Extraction, Device, Day, Hour, Place, Mood>. If no mood value can be extracted, then the resulting “7×1” matrix can have a value of 0 for mood. The resulting “7×1” matrix is then used to updated the particular contextual user profile 508.

### System Architecture for Creating and Updating Contextual User Profiles

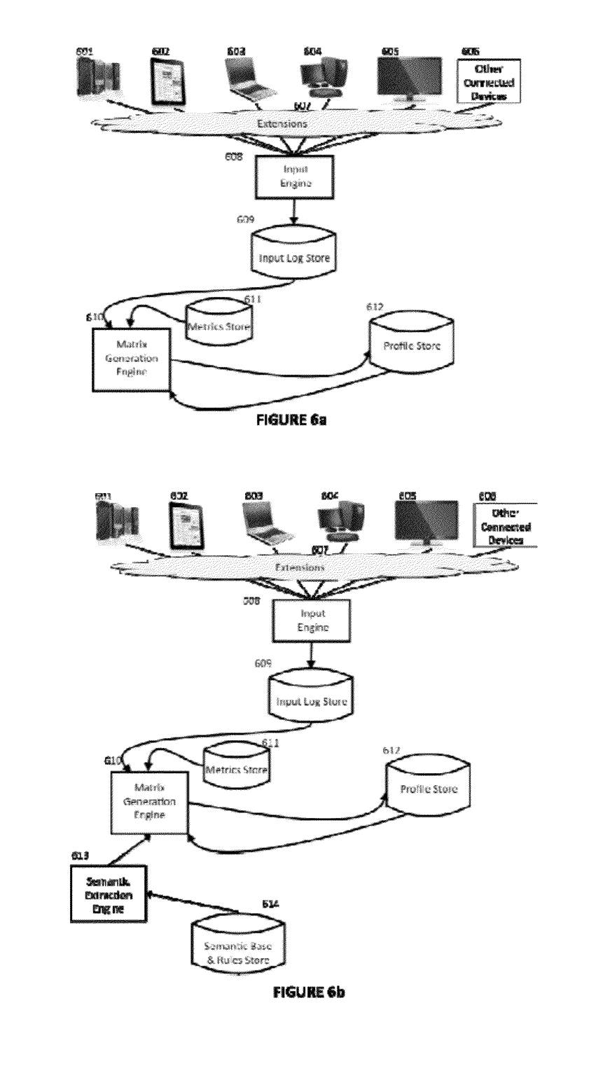

According to an embodiment of the present invention, the various elements of the system may be assembled into an architecture as represented by FIGS. 6a and 6b. The input engine 608 logs user actions on the Internet-connected devices (601-606) via the extensions 607, and stores them in the input log store 609. The raw log data extraction modules and data analysis modules are executed by the matrix generation engine 610 based on the data stored in the metrics store 611 and the user actions stored in the input log store 609. The input log store 609, metrics store 611 and profile store 612 may be represented by database servers. The input engine 608 and matrix generation engine 610 may be represented by application servers.

If the User Action is not listed in the metrics store 611, the interpretation process performed by the matrix generation engine 610 is aborted and the data logged in the input log store 609 is either kept stored in the input log store 609 until such time as additional metrics are added to the metrics store 611, or deleted, depending on the implementation. Indeed, the metrics store 611 lists databases of different actions, objects, <User, Action/Sentiment, Object/Concept> value extractions, among others. These databases may be expanded by engineers that list new value extractions for new <User, Action/Sentiment, Object/Concept>. Therefore, as additional metrics are added to the metric store 611, all data logged and not yet interpreted can go through the interpretation process. Indeed, if and/or when there is no longer any data to log from the input engine 608, the matrix generation engine 610 may run “in the background” to process all data logged in the input log store 609. Chronologically, every action logged by the extensions 607 is processed by the input engine 608 which registers all inputs from the local extensions 607 in each device in the input log store 609, along with contextual information such as device used, day, hour and place.

If the User Action in the input log store 609 is listed in the metrics store 611, the User Action will be interpreted by the matrix generation engine 610. The resulting processed input <User, User Action, Device, Day, Hour, Place> is still stored in the input log store 609. Processed inputs may represent the User Action interpreted by the matrix generation engine 610 and stored in the input log store 609. Non-processed inputs may represent the User Action that either did not go through the interpretation process by the matrix generation engine, or saw the interpretation process aborted as non-listed in the metrics store 611. According to an embodiment of the present invention, processed inputs may be separated from non-processed inputs in the input log store 609. All written input stored in the input log store 609 may be processed semantically and separated from non-processed inputs in the input log store 609.

All the data analysis algorithms described above may be implemented either by the matrix generation engine 610 or by a dedicated processing unit, possibly outsourced, 613 in FIG. 6b. All the rules and metrics to implement those algorithms may be stored in the metrics store 611 or in dedicated database servers (614 in the FIG. 6b). The raw data log <User, User Action, Device, Day, Hour, Place> stored in the input log store 609 may be used to extract mood to add this contextual information to the input and to update the user profile stored in the profile store 612.

Each user action may be listed as having either some explicit value or implicit value in the metrics store 611. In one embodiment, the difference that may be considered between the two lists is that the explicit-value user action has similar meaning for every user, which may not be the case for implicit-value user actions. Therefore, for each explicit-value listed User Action, a corresponding vector column “n×1” has been defined to update the user profile multi-dimensional matrix. The vector column “n×1” is converted to a matrix of similar dimensions as that of the profile, in consideration of the context attached to the processed input <User, User Action, Device, Day, Hour, Place>.

On the other hand implicit-value user actions can have different values in the corresponding vector column “n×1”, depending on the user profile. One instance is that in the case of a user that often rates the videos he or she watches, the absence of rating after video consumption may indicate that the user did not like the video. However, in the case of a user that never rates the videos he or she watches, this absence of rating has a neutral value.

According to an embodiment of the present invention, all User Action's implicit values are stored within the user profile matrix as some of the criteria, indicating for each implicit value listed in the metric store 611 the interpretation adapted to the user profile. In a variant, the profile store 612 stores for each user profile matrix a list of interpretation values for each implicit value stored in the metrics store 611. This list of interpretation values is updated with all User Actions to the user profile's updates. It is to be noted that some of the values extracted through this process are used to update the user profile matrix, but some are used to extract some information on the context of the user, especially his mood, at different times of the day, as described above.

A particular item's profile may take popularity of the item into account, which may evolve every ten weeks in an embodiment of a recommendation engine. Similarly, contextual user profile may add a time factor reducing continually the value of a processed input on the user profile with time. This may actualize the contextual user profile, as the user may change preferences with time. For example, as a teenager grows older, his or her preferences may change and embodiments of the present invention can accommodate those changing preferences.

### Contextual Recommendations

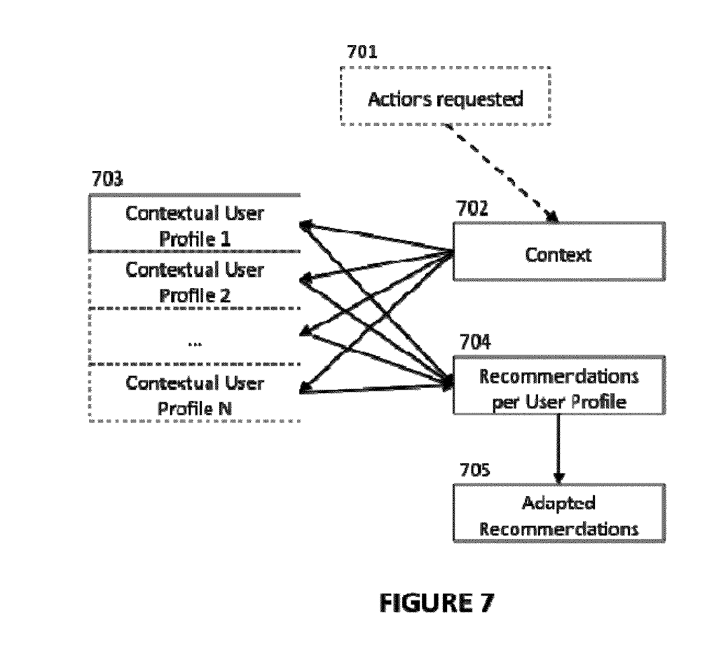

The resulting contextual user profile can then be used for many different purposes, including for making highly relevant and contextual recommendations. FIG. 7 illustrates how recommender systems may use contextual user profiles this purpose among others.

According to an embodiment of the present invention, suppose 3 users want to watch a movie on Friday night from their Internet-connected television sets. “Watch a movie” is an action requested 701. The time (Friday night) and place have been logged by the extensions connected to each User's Internet-connected television set. Users 1 and 3 have posted many tweets on Twitter while User 2 has posted less than her average daily number of tweets. The mood extraction module (see 506 on FIG. 5) has determined that User 2 is in a bad mood based on her lower-than-normal tweet volume and on the information gathered semantically from the comments or tweets of User 2 on different websites or social networks. Now that the context 702 for Users 1-3 (e.g., time, place, mood, action) has been set and each contextual user profile 703 updated, collaborative filtering techniques, among other known recommendation algorithms, may be applied to each User's profile to make a recommendation 704 (e.g., suggest a particular movie that each User may be interested in watching). An intersection showing the best compromise between the three lists of preferences will render contextual recommendations.

Another example may represent a User looking for an activity on Saturday evening. The User's current contextual profile indicates that the User has an affinity for theater and Japanese food on some previous Saturday evenings, and thus may recommend this type of activity for the current Saturday evening.

### Semantically Enhanced Contextual Recommendations

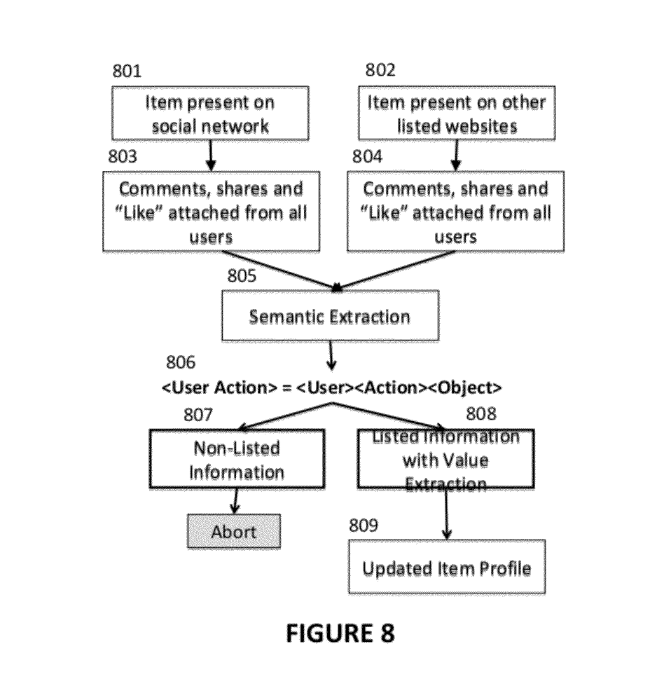

The semantic extraction module can be used to gather additional information on the activity or content of various social networking sites or websites, among others. The comments or articles present on the social networks or websites visited by the User are sources of information that can be treated by the semantic extraction module to update the items' profiles that were previously built on the available metadata. Such comments or articles viewed by the User may originate from other users or, alternatively, may be limited to only the friends of the users present on a particular social networking site. The item can thus follow an update process similar to the one described for the contextual user profile as set forth FIG. 8. The item profiles might be contextual as well by considering the context of the different inputs, that is the articles, comments, share and likes among others on websites and social networking sites. However, the inputs (e.g., user comments) may be written at different times from the actual usage of the items. Therefore, the thoroughness of the contextual dimensions of an item profile may be in doubt and not worthy for commercial purposes.

In one embodiment, items are identified that are present on a user's social network 801 or on other websites 802. Comments, shares, etc. from the social network 803 and from the websites 804 are also identified. These comments, shares, etc. are combined and a semantic extraction process 805 may be used to extract information including <User><Action><Object> associated with a <User Action>. This information may be separated into non-listed information 807 and listed information 808. If the information is non-listed 807, the update process may be aborted. If the information is listed 808, then the item profile may be updated 809.

Still, this item's profile update process, without considering the context as described in the FIG. 8, will improve the quality of the profile and thus the outcome of the recommendations. Comments on websites or social networking sites can also be used to create social recommendations as described below.

Social Recommendations with or without Consideration of the Context

Embodiments of the present invention are also capable of describing social recommendation rules that may help build a contextual social recommendation engine. The increased use of social networking sites such as Facebook or Twitter means that a significant portion of logged user actions could come from such social networking sites. For example, user updates of their Facebook status likely contains rich information about the user's mood and other activities throughout the day which can be easily logged by the system. Social recommendations can be built for one user by extracting certain information from friends and acquaintances of the user. This provides an additional filtering technique since the recommendation is built based on other users with whom the primary user has some sort of affinity or relationship.

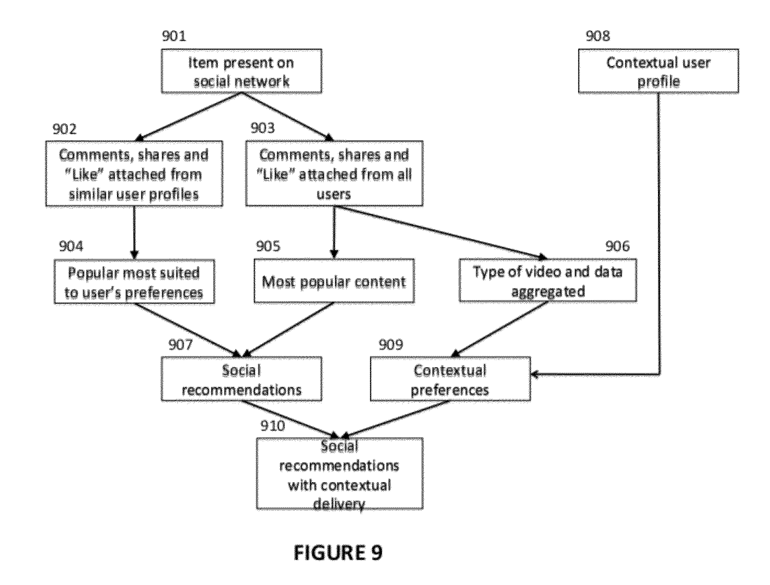

Indeed, according to an embodiment of the present invention and referring to FIG. 9, social recommendations on items not having descriptive information (e.g., metadata for video content) may be delivered. The method concerns only items present on social networks, which stands for the majority of cases as social tools are expanding to most platforms.

For each item 901 present to users on a social network, such as Facebook or Twitter, the number of shares, of comments and of “likes” can be aggregated on the whole user base to assess the “popularity” of the item 903. In this way, the system can determine the most popular content 905. In addition, the number of shares, comments and likes made by users having a similar profile 902 to the current user profile can also be aggregated. This information represents popular content that is most suited to the current user's preferences 904. In one embodiment, shares, comments and “likes” may be given the same importance relative to one another. In a variant, shares may have more significant value than comments, which may have more value than “likes.”

A combination of the most popular content 905 and those most suited to a particular user's preference 904 can be used to make “social recommendations” 907 in which items are shown to a user who otherwise would not have any information on the item itself. For instance, we could rank the videos on two different lists corresponding to the most popular content 905 and the one most suited to the user's preference 904. Social recommendations could be the items with the best average ranking on both lists.

This process can be applied to the user's friends in the social network, instead of the users with a similar profile 902 or of the whole user base. Indeed, aggregating the number of social actions as sharing, commenting and likes may show the “popularity” of the item among the user's friends, which may end up in social recommendations, here to be understood as recommendations from the user's friends.

Furthermore, this process can be improved by adding contextual information based on the type of content delivered. Indeed, the item type can be retrieved from the social network whether it is an article, a picture or a video 906. Contextual preferences 909 such as comments give indications on the content of the item (e.g., a particular video may be a comedy or may be political). This information can be used to build a “n×1” column vector for the item profile. The item profile may then be compared to the user's contextual user profile 908 in order to refine recommendations 910 made by the social recommendation module 907.

### System Architecture for Contextual and Social Recommendations

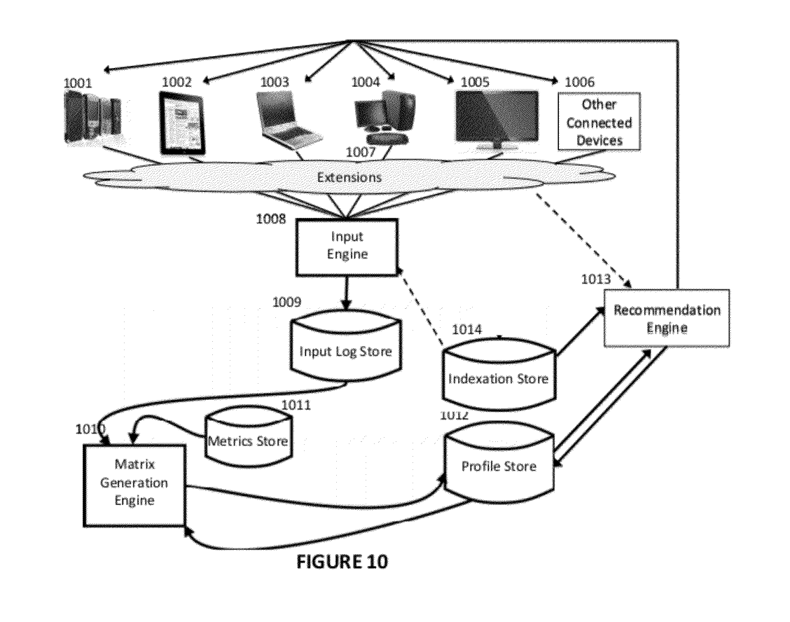

According to an embodiment of the present invention, the various elements of the system may be assembled into an architecture as represented by FIG. 10. The item profile update process can be supported by the same architecture as the one of the contextual user profile creation and update process, presented in FIGS. 6a and 6b. The input engine can log the inputs it has access to on the items that have been indexed in the indexation store 1014. These inputs are then stored in the input log store 1009 before being processed by the matrix generation engine 1010 and updating the item profile in the profile store 1012. According to an alternate embodiment of the present invention, the profile store 1012 and indexation store 1014 may form only one store. The recommendation engine 1013 will use all profiles and all links between these profiles, should it be their similarities or their “friendship” or “following”/“followers” relationships on social networking websites stored in the profile store 1012 to implement known recommendation algorithms, such as collaborative filtering among others, in a contextually and multi-dimensional way. The indexation store 1014 compiles information for identification and retrieval of each of the items recommended by the recommendation engine in order to be displayed in the consumption interfaces 1001-1006. The items may be directly displayed or presented on these interfaces through extensions 1007. The recommendation engine 1013 may be activated automatically or by one of the consumption interfaces with a specific request from the user.

### Building Customized Lists of Content

Media is typically consumed in lists and each list comprises a linear series of similar content that may or may not have an end point. The following are examples of lists:
music playlists and music albums as series of songs
magazines and newspapers, should they be physical or digital, as series of articles
TV channels or web video channels, as series of videos

According to an embodiment of the present invention, these lists comprise one or more series of recommended actions that a user may take. For example, recommended actions could include going to the movie theater, eating at a certain restaurant or viewing a certain program or video. These lists may be dynamic in that new content can be continually added to the list. In addition, existing content within the list can be modified if considered more appropriate from a recommendation standpoint.

According to an embodiment of the present invention, contextual user profiles can be used to create customized lists of content in an optimized way as the context evolves along the list. In this way, the list can take into account, for example, the amount of time it may take a user to view a video or eat at a particular restaurant. The context user profile can then change in real time based on before and after states of the user.

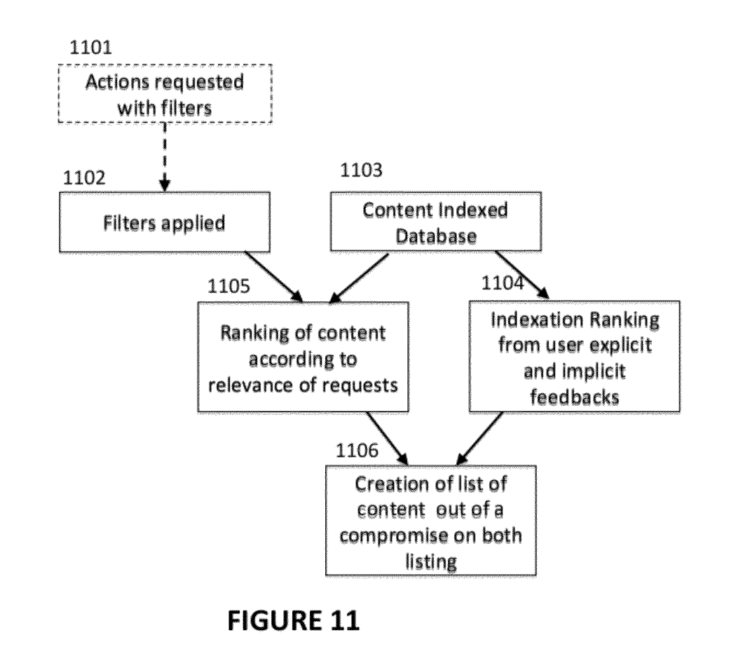

FIG. 11 depicts a flowchart of a method for creating lists of content from explicit user requests such as keywords and filters. This figure is merely illustrative for purposes for using existing indexing and ranking methods, and is not intended to limit the scope of the invention. According to an embodiment of the present invention, the filters applied 1102 may be “keywords” or “tags” describing the content, length description, targeted audience description, content sources 1101. For instance, some video channels can be created with a few keywords and filters. In general, more importance is attributed to the ranking according to the relevance with the request and filters used 1105, as the expected customized list output is first to answer the user's request. In addition, content from a content indexed database 1103 may be used in the ranking of content according to the relevance of requests 1105 and an indexation ranking from user explicit and implicit feedback 1104. The present invention improves the output 1106 of the list of content creation process by using contextual and/or social recommendations.

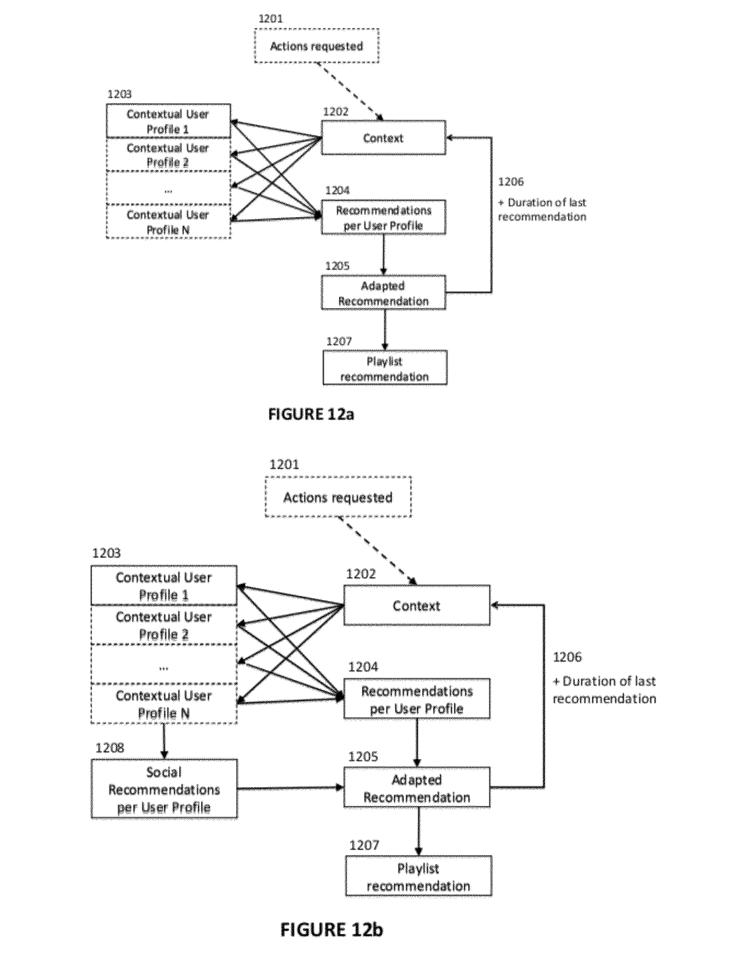

FIG. 12a illustrates how recommender systems may use contextual user profiles to create customized lists. Conventional user profiles can also be used in a similar way to create customized lists.

According to an embodiment of the present invention, suppose two users want to watch videos on a Saturday evening. “Watch videos” is the action requested 1201. The time (Saturday evening) and place have been logged by the extensions as well as the mood of both users by the mood extraction module (see 506 on FIG. 5) throughout the day. Now that the context 1202 has been set for Users 1-2 (i.e., time, place, mood, action) and that each contextual user profile 1203 has been updated, recommender algorithms, such as collaborative filtering techniques, may be applied to each User's profile to make a set of recommendations 1204. An intersection showing the best compromise between the two lists of preferences will render a contextual recommendation 1205 with a video of a defined duration. The process is repeated 1206 after taking into account the duration of the first recommendation. So the context of the second iteration will be the same context as the first one, except for the time as the second video will begin after the first one. Several iterations of the method enable the system to render a contextual playlist recommendation 1207.

FIG. 12b illustrates the fact that social recommendations can also be integrated in the list above. According to an embodiment of the present invention, social recommendations 1208 can be applied to the recommendations for each user profile before determining the best compromises for an item recommendation within the list.

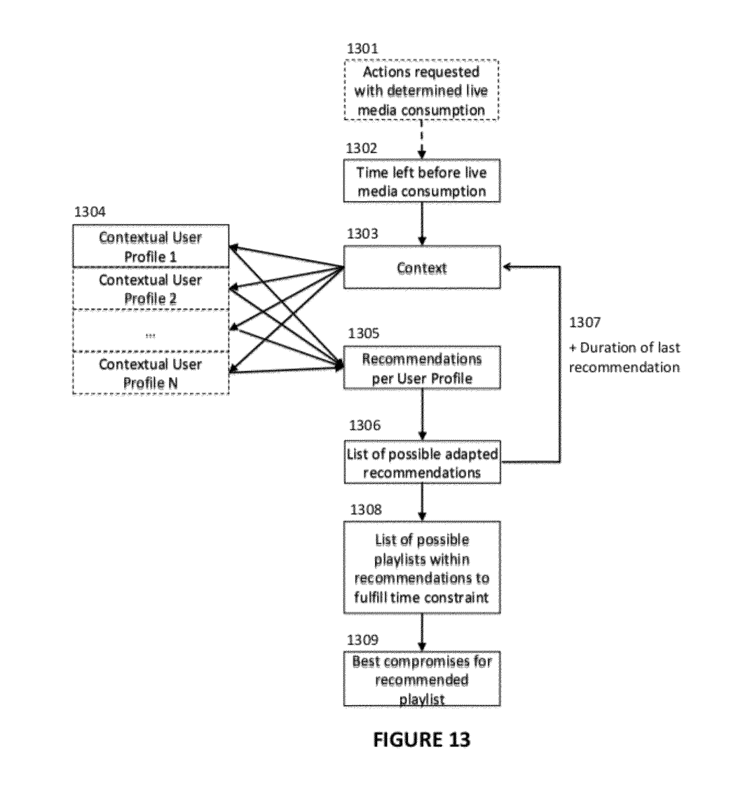

FIG. 13 describes a methodology adaptable to any time constraint according to an embodiment of the present invention. By way of example and not limitation, suppose a user that desires to watch a certain television program on Monday evening at 10 pm in real-time versus recording the program and watching it later 1301. This particular user preference can be added to the user's profile automatically or the user can expressly add it to the information to the profile. Assume that it is 8:05 pm and there is 1 hour and 55 minutes remaining before the user's show is broadcast live 1302. This may form the context of the request 1303. According to an embodiment of the present invention, the system can recommend a list of video content 1305 adapted to the user's preferences 1304 having a duration of 1 hour and 55 minutes to fill the time before the live show is broadcast. The process described in FIG. 13, and similar to the one in FIG. 12, enables exemplary embodiments to create a first set of recommendations. In one embodiment of the present invention, the smallest time duration that can be found within the first list of videos being recommended in the first set of recommendations is used to determine the context for a second iteration. This process goes on several iterations 1307 until the 1 hour and 55 minutes of content is reached. In this manner, a list of recommendations is produced 1306. The list may be produced based on a period of time between a current time and the time of the live broadcast and the content items in the list may have a total length that is not greater than the period of time. The content items in the list of recommendations may be in an order according to the constraint (i.e., the time of the live broadcast) and based on an anticipated viewing of the content items in the list. The order may account for the length of each content item in the list, so that each recommended item is appropriate for the time at which a previous item in the list is completed. By taking one video from each set of recommendations, some combinations are built to obtain lists with the desired duration (i.e., 1 hour and 55 minutes according to the example set forth above) 1308. Among these lists, the one that is kept as final recommendation is the one most appropriate to the contextual user profile along the list 1309. Social recommendations can be applied to the process described above, in a similar way to FIG. 12b.

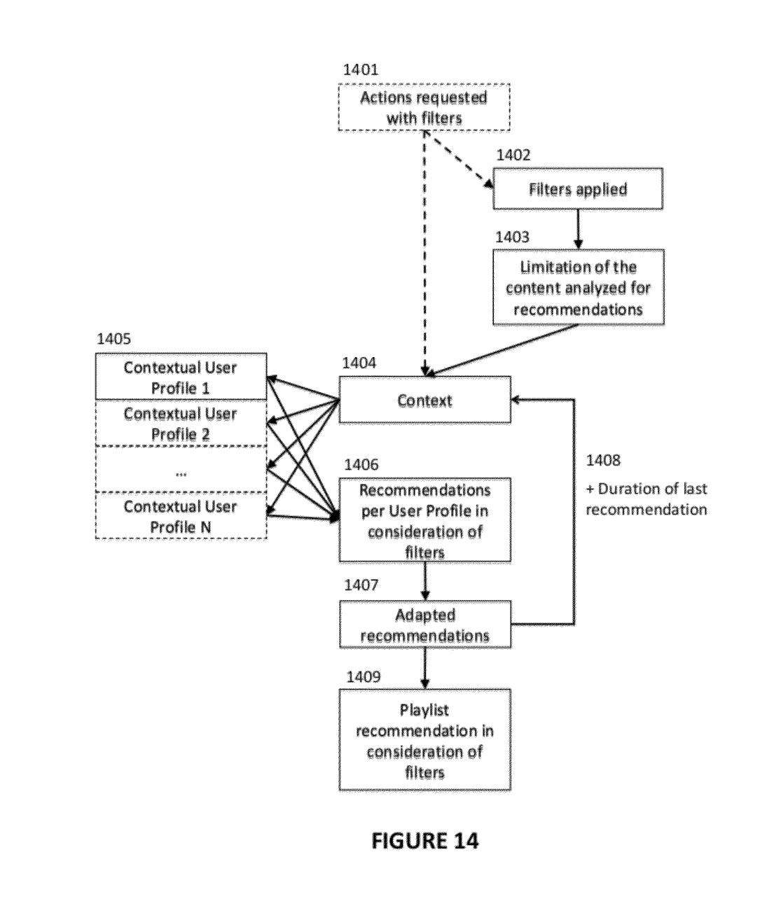

FIG. 14 illustrates how users can create their own lists based on their contextual user profile according to an embodiment of the present invention. Such user control is achieved by allowing users to add filters to alter the proposed lists. Filters may be used to limit the content database that can be recommended in the list. According to an exemplary embodiment of the present invention, suppose that the requested actions 1401 indicate that one user would like to create a channel that shows only movies related to dinosaurs. The user logs the tag “dinosaur” as a filter 1402 to filter out 1403 content that does not contain metadata referencing dinosaurs, or similar terms. Additional preferences can be logged in the list creation system, or channel builder as it may be called, to add filters such as “only long-form movies” and specify certain content sources from which to build the list. Such content sources may comprise VOD services, network channels, studios or web content publishers or aggregators. One having ordinary skill in the art will appreciate that various filters may be added including, for example, filters pertaining to audience type (e.g., adults only), genre and mood of the content, duration of the content and availability filters. The limitation of the filters may be used to form the context 1404 of the request, which when combined with preference information from user profiles 1405 may generate a recommendation 1406. The process may be repeated 1408 to generate a list of adapted recommendations 1407, from which a playlist of recommendations in consideration of the filters may be formed 1409.

With all the information derived from the different filters used by the user, the process described in FIG. 12a, or 12b if social recommendations are integrated, can be used on the content database defined by the filters. This will render a contextual, potentially social as well, recommendation list with respect to the filters used.

### System Architecture for Creating Contextually Customized List of Content

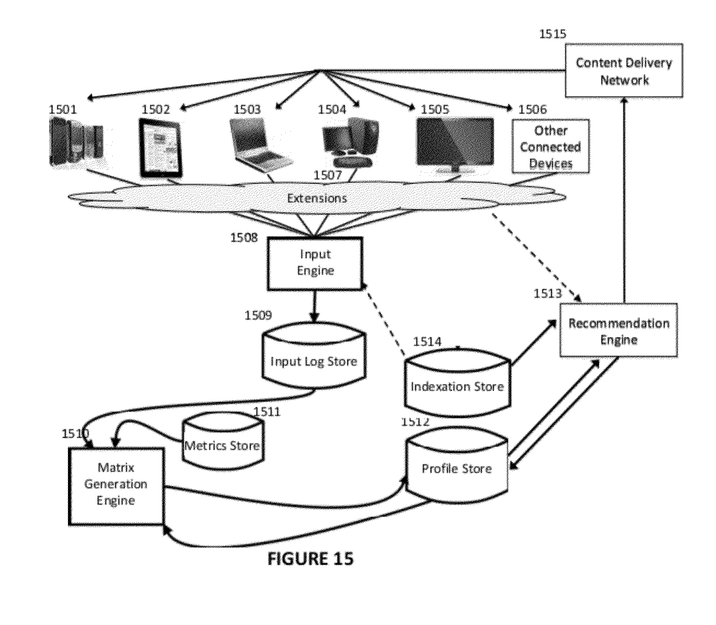

According to an embodiment of the present invention, the various elements of the system may be assembled into an architecture as represented by FIG. 15. The recommendation engine 1513 can implement the methods described above to create customized lists of content based on the item profiles and contextual user profiles. The content may be streamed directly from servers in which the content has been indexed to be hosted or via a content delivery network 1515 that will keep copies of the content to maximize bandwidth and avoid bottlenecks. Such content may be delivered to a particular connected device 1501-1506 as specified by the user. The architecture may additionally include input engine 1508, input log store 1509, matrix generation engine 1510, metrics store 1511, profile store 1512, and indexation store 1514, which have been described above, at least with respect to FIG. 10.

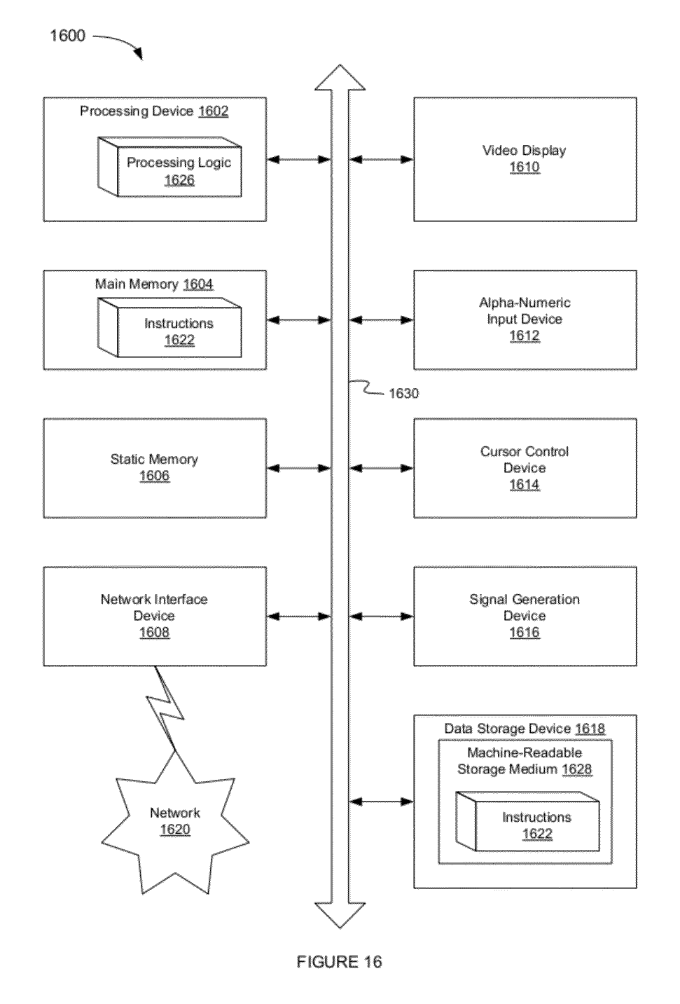

FIG. 16 illustrates a diagrammatic representation of a machine in the exemplary form of a computer system 1600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1600 may be representative of a computing device having the architecture described in FIG. 6a, 6b, 10, or 15.

The exemplary computer system 1600 includes a processing device 1602, a main memory 1604 (e.g., read-only memory (ROM), flash memory, dynamic random access memory (DRAM) (such as synchronous DRAM (SDRAM) or Rambus DRAM (RDRAM), etc.), a static memory 1606 (e.g., flash memory, static random access memory (SRAM), etc.), and a data storage device 1618, which communicate with each other via a bus 1630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1602 may also be one or more special-purpose processing devices such as an application specific integrated circuit (ASIC), a field programmable gate array (FPGA), a digital signal processor (DSP), network processor, or the like. The processing device 1602 is configured to execute processing logic 1626 for performing the operations and steps discussed herein.

The computer system 1600 may further include a network interface device 1608. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), and a signal generation device 1616 (e.g., a speaker).

The data storage device 1618 may include a machine-accessible storage medium 1628, on which is stored one or more set of instructions 1622 (e.g., software) embodying any one or more of the methodologies of functions described herein. The instructions 1622 may also reside, completely or at least partially, within the main memory 1604 and/or within the processing device 1602 during execution thereof by the computer system 1600; the main memory 1604 and the processing device 1602 also constituting machine-accessible storage media. The instructions 1622 may further be transmitted or received over a network 1620 via the network interface device 1608.

The machine-readable storage medium 1628 may also be used to store instructions to perform a method for creating and using contextual user profiles, as described herein. While the machine-readable storage medium 1628 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method comprising:
receiving an indication of an action performed on a resource by a user of a user device;
storing context data corresponding to the action;
analyzing, by a processing device, the indication of the action with respect to the context data, to determine a user affinity value for a criteria associated with the resource; and
storing the user affinity value for the criteria in a contextual user profile associated with the user.

2. The method of claim 1, wherein the action comprises one of a pre-defined list of actions associated with the resource.

3. The method of claim 1, wherein the resource comprises at least one of a web-page or a network connected computer application.

4. The method of claim 1, wherein the user device comprises at least one of a smartphone, a tablet computer, a laptop computer, a desktop computer, a television set, or a set-top box.

5. The method of claim 1, wherein the context data comprises at least one of a user identity, an indication of the user device, a date the action was performed, a time the action was performed, or a location the action was performed.

6. The method of claim 1, wherein analyzing the indication of the action with respect to the context data comprises:
comparing the indication of the action to reference data based on the context data;
determining an interpretation value based on the comparison to the reference data; and
determining the affinity value from the interpretation value.

7. The method of claim 1, wherein storing the user affinity value in a contextual user profile comprises generating a multi-dimensional matrix comprising the user affinity value and one or more additional user affinity values, wherein each dimension of the matrix corresponds to a different contextual factor or criteria, and wherein each of the one or more additional user affinity values correspond to a change in the different contextual factors or criteria.

8. The method of claim 1, further comprising:
receiving a request for content from the user of the user device;
identifying a context of the request based on context data;
comparing the context data to the contextual user profile associated with the user; and
identifying a resource based on the comparing to satisfy the request for content.

9. The method of claim 8, wherein comparing the context data to the contextual user profile comprises identifying a user affinity value for the context data from the contextual user profile.

10. The method of claim 9, wherein identifying the resource comprises comparing the user affinity value to a resource value to determine if the resource is recommended for the user.

11. The method of claim 10, wherein identifying the resource further comprising comparing the user affinity value to resource values from one or more other user profiles associated with users who have a virtual connection to the user.

12. The method of claim 10, further comprising:
if the resource is recommended to the user, providing the resource to the user to satisfy the request for content.

13. A system comprising:
a processing device;
a memory coupled to the processing device; and
a profile generation engine, executable by the processing device from the memory, to:
receive an indication of an action performed on a resource by a user of a user device;
store context data corresponding to the action;
analyze the indication of the action with respect to the context data, to determine a user affinity value for a criteria associated with the resource; and
store the user affinity value for the criteria in a contextual user profile associated with the user.

14. The system of claim 13, wherein analyzing the indication of the action with respect to the context data comprises:
comparing the indication of the action to reference data based on the context data;
determining an interpretation value based on the comparison to the reference data; and
determining the affinity value from the interpretation value.

15. The system of claim 13, wherein storing the user affinity value in a contextual user profile comprises generating a multi-dimensional matrix comprising the user affinity value and one or more additional user affinity values, wherein each dimension of the matrix corresponds to a different contextual factor or criteria, and wherein each of the one or more additional user affinity values correspond to a change in the different contextual factors or criteria.

16. The system of claim 13, further comprising:
a recommendation engine, executable by the processing device from the memory, to:
receive a request for content from the user of the user device;
identify a context of the request based on context data;
compare the context data to the contextual user profile associated with the user; and
identify a resource based on the comparing to satisfy the request for content.

17. The system of claim 16, wherein comparing the context data to the contextual user profile comprises identifying a user affinity value for the context data from the contextual user profile.

18. The system of claim 17, wherein identifying the resource comprises comparing the user affinity value to a resource value to determine if the resource is recommended for the user.

19. The system of claim 18, wherein identifying the resource further comprising comparing the user affinity value to resource values from one or more other user profiles associated with users who have a virtual connection to the user.

20. The system of claim 18, wherein the recommendation engine is further configured to:
if the resource is recommended to the user, provide the resource to the user to satisfy the request for content.

21. A non-transitory machine-readable storage medium storing instructions which, when executed, cause a data processing system to perform a method comprising:
receiving an indication of an action performed on a resource by a user of a user device;
storing context data corresponding to the action;
analyzing, by a processing device, the indication of the action with respect to the context data, to determine a user affinity value for a criteria associated with the resource; and
storing the user affinity value for the criteria in a contextual user profile associated with the user.

22. The non-transitory machine-readable storage medium of claim 21, wherein analyzing the indication of the action with respect to the context data comprises:
comparing the indication of the action to reference data based on the context data;
determining an interpretation value based on the comparison to the reference data; and
determining the affinity value from the interpretation value.

23. The non-transitory machine-readable storage medium of claim 21, wherein storing the user affinity value in a contextual user profile comprises generating a multi-dimensional matrix comprising the user affinity value and one or more additional user affinity values, wherein each dimension of the matrix corresponds to a different contextual factor or criteria, and wherein each of the one or more additional user affinity values correspond to a change in the different contextual factors or criteria.

24. The non-transitory machine-readable storage medium of claim 21, the method further comprising:
receiving a request for content from the user of the user device;
identifying a context of the request based on context data;
comparing the context data to the contextual user profile associated with the user; and
identifying a resource based on the comparing to satisfy the request for content.

25. The non-transitory machine-readable storage medium of claim 24, wherein comparing the context data to the contextual user profile comprises identifying a user affinity value for the context data from the contextual user profile.

26. The non-transitory machine-readable storage medium of claim 25, wherein identifying the resource comprises comparing the user affinity value to a resource value to determine if the resource is recommended for the user.

27. The non-transitory machine-readable storage medium of claim 26, wherein identifying the resource further comprising comparing the user affinity value to resource values from one or more other user profiles associated with users who have a virtual connection to the user.

28. The non-transitory machine-readable storage medium of claim 26, the method further comprising:
if the resource is recommended to the user, providing the resource to the user to satisfy the request for content.

29. A method comprising:
receiving a request for content from a user of a user device;
identifying a context of the request based on context data corresponding to the request;
comparing, by a processing device, the context data to a contextual user profile associated with the user, the contextual user profile storing a user affinity value for a criteria associated with a plurality or resources; and
identifying one of the plurality of resources based on the comparing to satisfy the request for content.

30. A method comprising:
receiving a request for content from a user of a user device;
identifying a constraint associated with the request;
determining, by a processing device, a plurality of content items based on context data from a contextual user profile associated with the user, wherein the plurality of content items satisfies the constraint; and
generating a list of recommendations selected from the plurality of content items.

31. The method of claim 30, wherein the constraint comprises a request to watch a live media program at a first time, wherein the method further comprises determining a period of time between a current time and the first time, and wherein the plurality of content items have a total length that is not greater than the period of time.

32. The method of claim 30, wherein the list of recommendations comprises content items in an order according to the constraint and based on an anticipated viewing of the content items in the list, wherein the order accounts for the length of each content item in the list.
